(19) United States
(12) Patent Application Publication
(10) Pub. No.: US 2012/0310872 A1
(43) Pub. Date: Dec. 6, 2012

(54) SYSTEM AND METHOD FOR EVALUATING DECISION OPPORTUNITIES

(75) Inventor: Patrick L. Anderson, East Lansing, MI (US)

(73) Assignee: Supported Intelligence, LLC, East Lansing, MI (US)

(21) Appl. No.: 13/486,691

(22) Filed: Jun. 1, 2012

Related U.S. Application Data
(60) Provisional application No. 61/492,707, filed on Jun. 2, 2011.

(51) Int. Cl. G06N 5/02

(52) U.S. Cl. 706/46

(57) ABSTRACT

A system and method for evaluating various decision opportunities faced by a person, where the person has the opportunity to take different actions over time, where the state of affairs in each time period and the action taken affect the reward or benefits received by the person at that time and the action is likely to affect the state of affairs in the next time period.

### CROSS-REFERENCE TO RELATED APPLICATIONS

This application claims the benefit of U.S. Provisional Application No. 61/492,707 filed Jun. 2, 2011, which is incorporated herein by reference.

### FIELD OF THE DISCLOSURE

This disclosure relates to the field of decision making and particularly to methods and systems employing a sequential decision making model.

### BACKGROUND OF THE DISCLOSURE

Investors, business managers, public officials, entrepreneurs, financiers, and individuals routinely make decisions that require considering the effects of future events that cannot be predicted with certainty. Large subsets of those decisions involve financial decisions, meaning actions to commit sums of money toward some purchase or investment, with the expectation of a future stream of benefits. This category of decisions might be called “investment under uncertainty,” although only a portion of such decisions is called “investments.”

Over the past three decades, computer software, hardware and networks have wonderfully increased the ability to analyze investment opportunities and other financial and business situations that involve uncertainty about future events and future decisions. The standard tool used for this purpose, across the United States and much of the world, is the spreadsheet. This allows for a straightforward calculation of the net present value of a specific stream of future earnings or expenses, and a comparison with an upfront payment.

Discounted Cash Flow (DCF) analyses done with spreadsheets—the common tool for evaluating investments—completely fail when used to evaluate a multi-period decision problem where asymmetric risk and real options are present. The failure is well known; managers commonly use intuition and adjust cash-flow schedules until they work. Evidence suggests that most organizations “use” a DCF model, but then actually decide on experience, gut instincts, or rules of thumb.

Two problems with standard DCF analyses are that they disregard vast amounts of available information and fail to explicitly consider the flexibility (often called “real options”) available to managers and investors.

An array of ad-hoc adjustments is commonly used to compensate for the weaknesses of the standard DCF model. However, there is no commercially available alternative to the spreadsheet that properly addresses these deficiencies, especially in the context of business, personal and policy problems. More sophisticated methods, such as Monte Carlo decision tree analysis, financial option models, and variations and/or combinations of these methods also have deficiencies.

SUMMARY OF THE DISCLOSURE

Disclosed are computer-aided decision-making systems and method for providing advice or recommendations and/or evaluations relating to various decision-making opportunities.

In certain aspects or embodiments disclosed herein, a computer-decision-making system includes a processor, a user input interface, a user output device, and a program executed by the processor to evaluate decision-making opportunities based on information from a database and/or user input. The program facilitates input of relevant information from a database and/or from a user via the user input interface; validation, checking and correction of input errors; generation of elements from the input that are used for formulating a functional equation; solving the functional equation, and presenting the user with advice via the user output device. The elements generated from the input information include (1) a set of states that describe possible outcomes, (2) a set of possible actions that may be taken by a decision maker, (3) a transition probability function representative of the likelihood of a particular state occurring at a future time based on the current state and the particular action taken by the decision maker, (4) a reward function representative of the benefits and costs associated with each possible action and state, (5) a discount factor that is representative of the relative preference for receiving a benefit now and at a future time, and (6) a time index that establishes a special ordering of events.

In certain aspects or embodiments, a computer-readable medium is provided. The computer-readable medium is coded with instructions that cause a data processing system to perform a process that includes obtaining information from a user or a database; validating, checking and correcting input errors; generating elements from the input that are used for formulating a functional equation; solving the functional equation; and presenting the user with output to assist the user with a decision making process. The information that is obtained from a user or a database pertains to (1) a set of states that describe possible outcomes, (2) a set of possible actions that may be taken by the decision maker, (3) a transition probability function representative of the likelihood of a particular state occurring at a future time based on the current state and the particular action, (4) a reward function representative of the benefit and costs associated with these possible action state, (5) a discount factor that is representative of the relative preference receiving the benefit now and at a future time, and (6) a time index that establishes a sequential ordering of events.

In accordance with certain embodiments and/or aspects, there is also provided a method for assisting a person making decisions using a rapid recursive analysis. The method includes steps of selecting a problem to be solved by a user via a user computer having a processor, a user input device, and a user output device. Steps of the process include providing the user with a user selectable option for defining a state associated with the selected problem, wherein the user indicates the state via the user input device; validating the user defined state, wherein the user may provide additional information if the user defined state is not validated; providing the user with a user selectable option for defining actions associated with the selected problem, wherein the user indicates the action via the user input device; providing the user with a user selectable option for defining a possible reward associated with the selected problem, wherein the user indicates that possible reward via the user input device and the possible reward is a potential benefit associated with the selected problem; providing the user with a user selectable option for defining a discount factor associated with the selected problem, wherein the user indicates the discount factor via the user input device; providing the user selectable option for defining a time index associated with the selected problem, wherein the user indicates time index via the user input device and the time index is expressed in periods associated with the selected problem; validating the action, reward, discount factor and time index, wherein the user may provide additional information if not validated; providing the user with a user selectable option for selecting a solution method for solving the selected problem; solving the problem using the selected method to determine a solution to the selected problem; and providing the user with the solution to the selected problem on the output device.

### BRIEF DESCRIPTION OF THE DRAWINGS

FIG. 1 is a block diagram illustrating the elements that are used by the analysis engine for implementing a method of providing decision making advice.

FIG. 2 is a flowchart illustrating a method disclosed herein.

FIG. 3 is a block diagram of a computer system for executing a software program for evaluating the elements shown in FIG. 1 and generating decision making advice.

FIG. 4 is a diagram illustrating the step of describing the problem to be solved.

FIG. 5 is a diagram illustrating an example of a financial problem.

FIG. 6 is a diagram illustrating an example of selecting a growth and a discount rate for a financial problem.

FIG. 7 is a diagram illustrating an example of selecting states and actions for a financial problem.

FIG. 8 is a diagram illustrating an example of selecting a reward for a financial problem.

FIG. 9 is a diagram illustrating an example of checking a validity of the input information for a financial problem.

FIG. 10 is a diagram illustrating an example of generating a reward matrix for a financial problem.

FIG. 11 is a diagram illustrating an example of setting up a transition probability matrix for a financial problem.

FIG. 12 is a diagram illustrating an example of generating a transition probability matrix for a financial problem.

FIG. 13 is a diagram illustrating an example of checking a transition probability matrix for a financial problem.

FIG. 14 is a diagram illustrating an example of a convergence and tension check of a transition probability matrix for a financial problem.

FIG. 15 is a diagram illustrating an example of selecting the solution algorithm for a financial problem.

FIG. 16 is a block diagram illustrating an example of reporting the solution algorithm for the financial problem example of FIG. 3.

FIG. 17 is an example of a report that can be displayed on a user output interface such as a display screen.

FIG. 18 is a diagram illustrating an application of the systems and processes described herein for evaluating information and providing advice relating to energy or resource consumption.

FIG. 19 is a diagram illustrating an application of the systems and processes described herein for evaluating information and providing advice relating to threat or risk assessment.

### DETAILED DESCRIPTION OF EXEMPLARY EMBODIMENTS

Opportunities that can be evaluated using the system and methods described herein include:
(a) whether to make a major purchase such as a house, car, or where the future value is uncertain;
(b) whether to make a financial investment in an instrument such as a stock, bond, or security where the future value of any dividend or income during the duration of the investment is uncertain;
(c) whether to take a course of action, such as remain in the workforce or to leave the workforce for the purpose of gaining more education or skills and later re-enter the workforce;
(d) whether to make a business decision such as a purchase of a controlling interest in another company, where that purchase would require an expenditure of funds and the resulting financial returns derived depends on the future success of the company where earnings are uncertain and managerial decisions may control or strongly affect the future value of the interest;
(e) whether to reinvest the earnings of an operating company in an effort to build capacity, improve products, or increase revenue where the alternative allows for a distribution of earnings to the owners, or to retain the earnings for future use; or
(f) whether to postpone an investment or other financial commitment in order to acquire additional information regarding the market, prices, technological developments, or other relevant factors.

A rapid recursive technique facilitates decision making that can be personal in nature, business related, policy related, or any other type of problem that can be described in the stated structure.

The systems and methods disclosed herein may be implemented using any of a variety of computing devices 20 (FIG. 3) having a processor 30, a user input interface 40 and output interface 50, and which are capable of executing a program as described for evaluating decision making opportunities. Examples of computing devices that may be used include personal computers, smart phones, tablet devices, personal digital assistants (PDAs), etc. The program may reside on a local storage device (e.g., a hard drive) or may be accessed over a local area network, wide area network, virtual private network, or other communications network.

The computing system 10 shown in FIG. 3 is illustrative and does not imply that processor 30 needs to be any particular structural configuration in relation to the other computer systems, including the user interfaces, which can be separate devices or devices that are incorporated into computer 20. For example, computer 20 can be a smart phone having an internal processor 30 and a touch screen that acts as both user input interface 40 and user output interface 50. Other examples of user input interfaces include a keyboard, a mouse and any other type of device in which a user is able to communicate information to a computing device. Methods of communicating with the devices could be wired, wireless, “cloud,” or other communication method.

The program used in the systems and methods disclosed herein can be provided on a computer-readable medium, such as a data storage disc (e.g., compact disc (CD), digital versatile disc (DVD), Bluray disc (BD), or the like), hard drives, flash drives, or any other computer-readable medium capable of storing instruction to implemented by a processor.

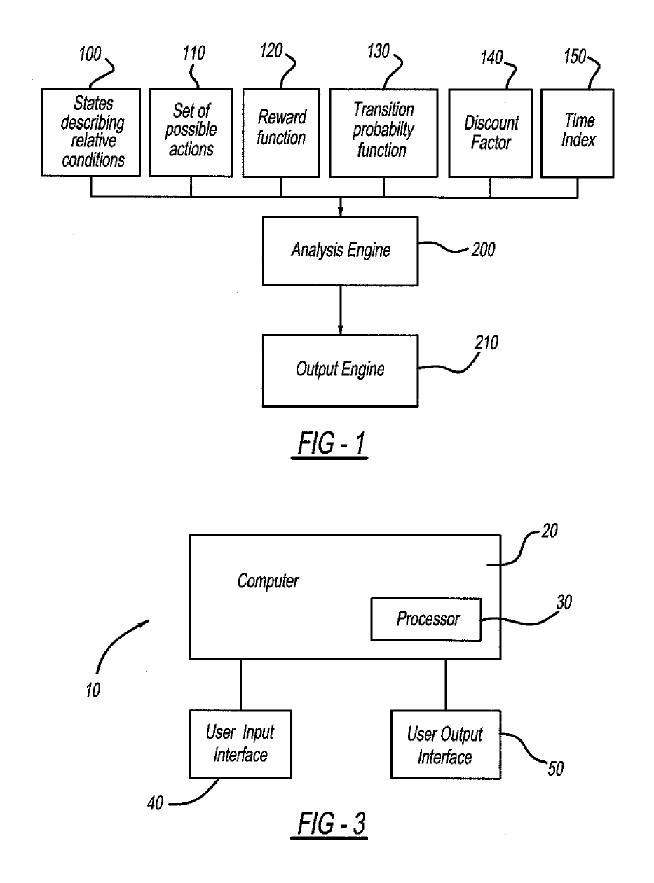

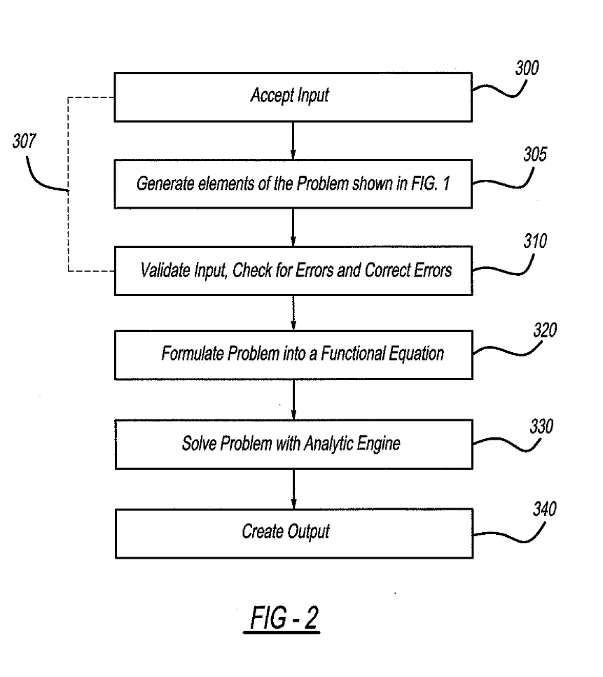

FIG. 1 is a block diagram that shows the elements 100, 110, 120, 130, 140 and 150 that generate information used by an analysis engine 200 that can transform this information into an estimate of value for each state and a ranking of a plurality of possible actions in those states. The output from the analysis engine can be filtered through an output engine 210 that presents the results from the analysis engine via a user output interface 50.

FIG. 2 is a flowchart illustrating a method as disclosed herein. The method involves accepting input at step 300, such as information or data relating to the states describing relative conditions 100, the set of possible actions 110, the reward function 120, the transition probability function 130, the discount factor 140, and the time index 150. The data or information may be obtained from a database associated with the particular problem or type of problem, a user inputted value or a default value. Thereafter, the elements 100, 110, 120, 130, 140 and 150 are generated at step 305. Validation tests and error checks can be performed at step 310, and optionally additional input (indicated arrow 307) can be requested if errors are discovered. The decision making software program may then formulate the problem into a mathematical expression referred to as a functional equation at step 320. At step 330, the formulated problem is solved using a predetermined analytical technique. The results are provided to a user at step 340.

The step of accepting input from a user, such as by a user input device or type of user interface 40 associated with a user computer system. Various types of input data may be provided, depending on the problem to be solved. The user may be provided with user selectable options on the user display device, such as on a screen or by an auditory output or the like. The user selectable options may allow for the selection of a representative problem. The user selectable options may prompt the user to input information necessary to define the selected problem, i.e. a possible state, action, reward, probability, discount rate or a time index. The user supplied information may be stored in a matrix format or other format offering computational efficiency.

User provided inputs can be validated and checked for errors by the decision making software program. For example, the decision making software program may prompt the user to correct a data entry via a pop-up screen, an error message or the like. In another example, the decision making software program may automatically correct the data.

The program sets up the selected problem to be solved using the information supplied by the user. For example, the decision making software program may formulate the problem into a particular type of mathematical expression referred to as a functional equation. The particular type of functional equation may be described in many forms, examples of which include but are not limited to a Markov Decision Problem with discrete states and action; a Value Functional Equation with some continuous states or actions; or a Bellman Equation or the like.

One or more validation tests may be performed. For example, a validation test of the data may be performed. In addition, conformance of the data (in terms of units, scale, dimension, size, periodicity, and the like) may be evaluated. The tension or trade-offs in the problem may be evaluated. In addition, it can be determined whether the problem meets criteria establishing that a solution to the problem can be obtained, and whether the solution algorithm will converge.

The formulated problem is evaluated using a predetermined analytical technique for solving a functional equation. Various types of analytic techniques may be utilized to solve the functional equation, such as value function iteration, policy iteration, root finding algorithm, or other numeric technique. In an example, one or more numeric techniques may be applied to solve the decision making problems.

Advice related to the formulated problem is provided to a user. For example, the advice may be indicated on a display device 50 associated with the user computer system 10. The solution may include a value to the user for each state and recommended course of action associated with each state.

An example of a decision that may be evaluated is whether to make a purchase, such as a house, a car, a financial instrument or the like. The method assumes that the user has options, such as the ability to postpone a purchase or action, continue on a course of action, or otherwise sell, unwind, or extricate themselves from a commitment to purchase or perform a specified action in the future.

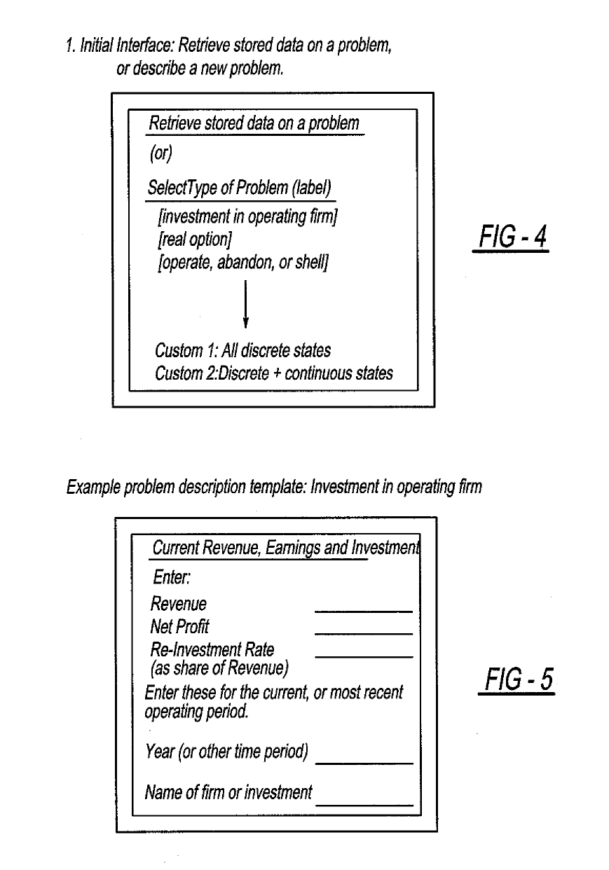

As shown in FIG. 4, a user may be presented with initial options for initially describing a type of problem or decision to be made or retrieve stored data already provided. The user may be prompted to select the type of problem to solve, i.e. make an investment, purchase real estate, continue to operate, sell or the like. The user may also be provided with a predetermined set of discrete states that describe the relevant conditions. Other examples of states may include revenue and net profit. The “state space,” may represent a condition in the current time period and/or a future time period, which may affect the person. Referring to FIG. 5, an example of a display screen illustrates a potential state if a user selects “whether to invest in an operating firm” option as the problem to be solved.

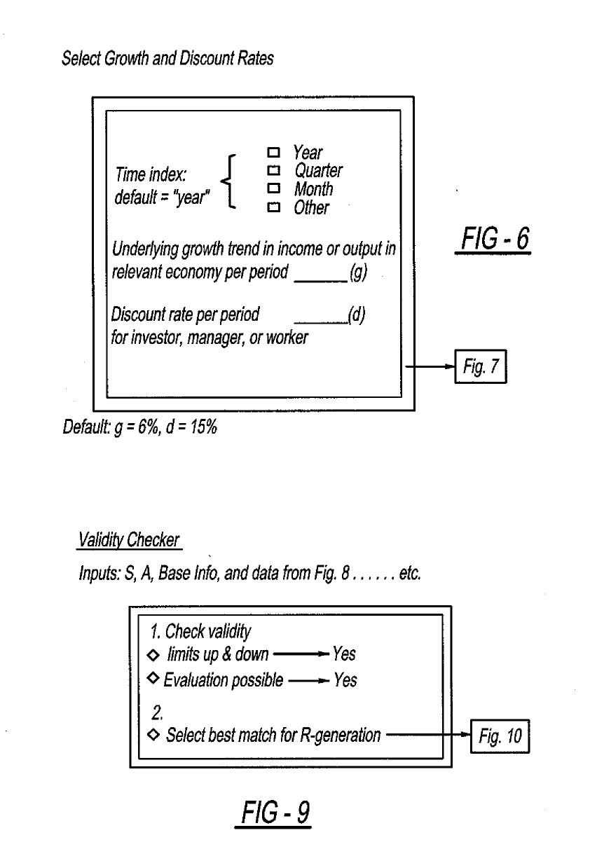

The user can be asked to provide information regarding a possible action associated with the decision making process. A set of possible actions is referred to as the “action space”. An action represents a path that the user may take. Referring to FIG. 6, the user in this example is prompted to input further data representing a growth rate and a discount rate over a period of time. The inclusion of information regarding the growth and discount rate allows the problem to be solved quickly since it establishes a mathematical boundary for the problem.

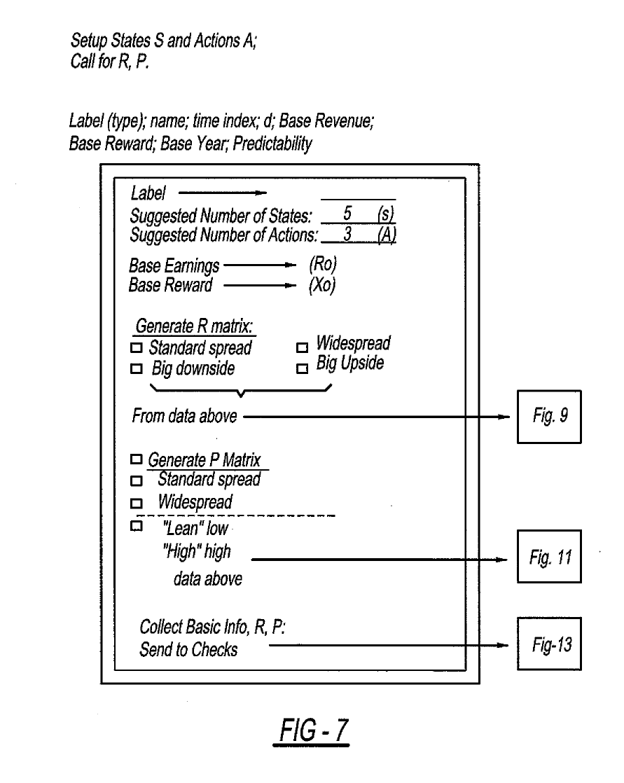

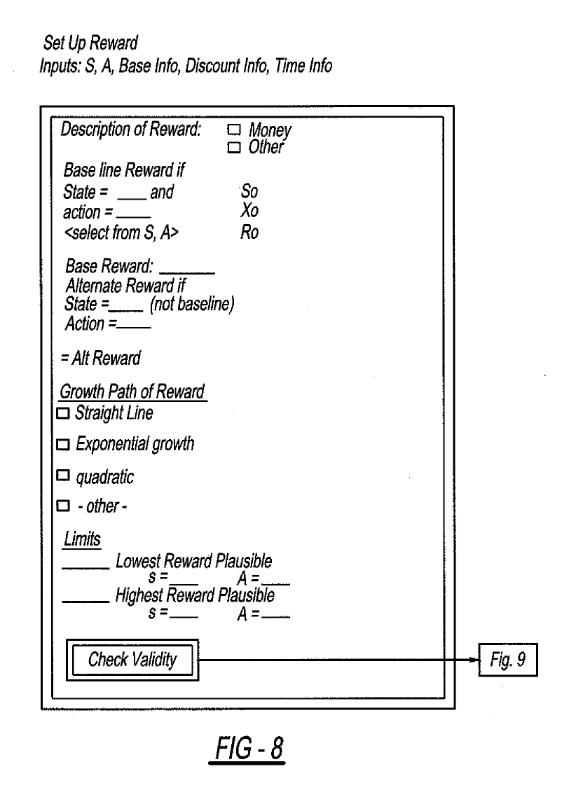

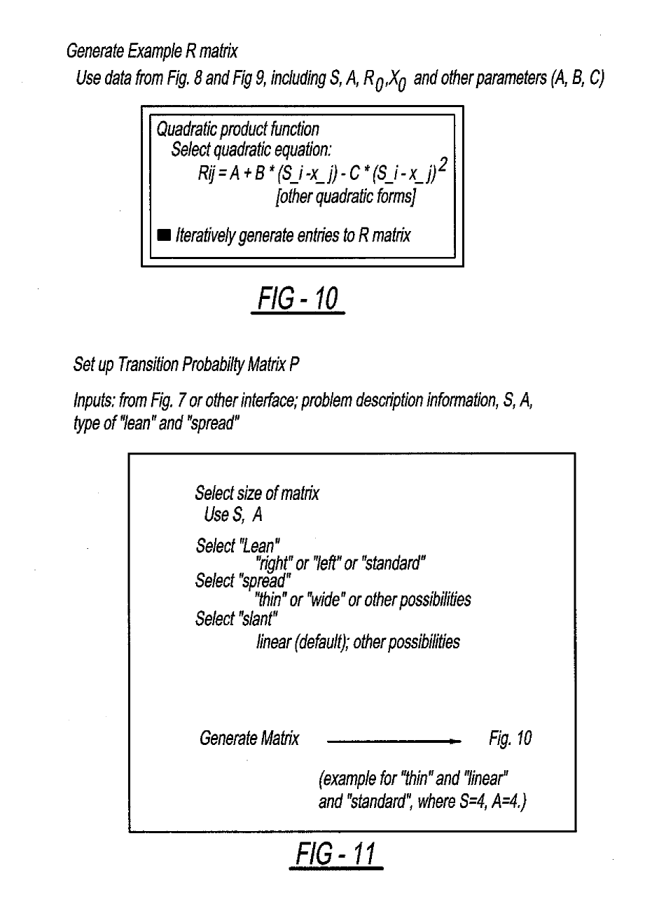

Referring to FIG. 7, the user may be provided with a screen display prompting the user to further define the problem to be solved in terms of a reward or a transition probability.

The state and action information provided by the user is organized, such as within a matrix. The size of the matrix is determinable based on the number of states and actions. For example, 3 state inputs and 4 action inputs could be stored in a corresponding 3×4 matrix.

A potential reward function is generated based on the user's assessment of potential rewards or outcomes associated with the problem to be solved, and incorporates the user perspective into the model. Advantageously, multiple actions may be evaluated at the same time as in the example of setting up a reward function illustrated in FIG. 8. The reward function is flexible, and represents a benefit relative to the user for each possible combination of an element from the action space and an element from the state space.

Within the combination of both action space and state space, the program solves problems, such as those that include asymmetrical, non-parametric, non-typical, and other types of risks. The problem may not require the use of risk-free rates or the assumption of common, predetermined statistical models. Further, in an example of a financial decision, the reward function has the flexibility to consider options outside of standard financial options contract terms. The reward function may be represented in a matrix format, although other formats are contemplated.

A user initially provides input that may include state information, action choices, discount rate information, time information, and the like. Other types of reward parameters include the type of reward desired, or base reward or alternative reward that may be available. The user may be prompted to select a shape of the growth path of the reward with respect to the set of actions and/or set of states and/or time, such as a straight line, exponential growth, quadratic growth or some other path. The user may further be prompted to provide information regarding potential reward limits, such as a minimum reward and maximum reward. The methodology may take a baseline reward number provided by the user and other parameters to construct a reward function. If the baseline reward is known, then an alternative reward may be determined.

A validity check may be performed to confirm the accuracy of the state, action and reward function information input by the user to insure a solution to the problem may be obtained, an example of which is shown in FIG. 9. For example, the data may be checked to determine if the values are within predetermined limits, i.e. an upper bound or a lower bound. In another example, the data may be checked to determine that certain values are greater than zero to avoid an indefinite solution. A convergence check can be used to evaluate whether the problem as defined is likely to be solvable using the available solution methods. A tension or trade-off check can be used to evaluate whether the defined problem includes a trade-off between the user's current reward value and likely discounted future value or discounted future rewards.

Using the data, a reward matrix is generated (FIG. 10) for the problem to be solved. The reward matrix may be multi-dimensional matrix, and include rows and columns corresponding to states, actions, and other relevant parameters. The reward matrix may be generated in an iterative manner.

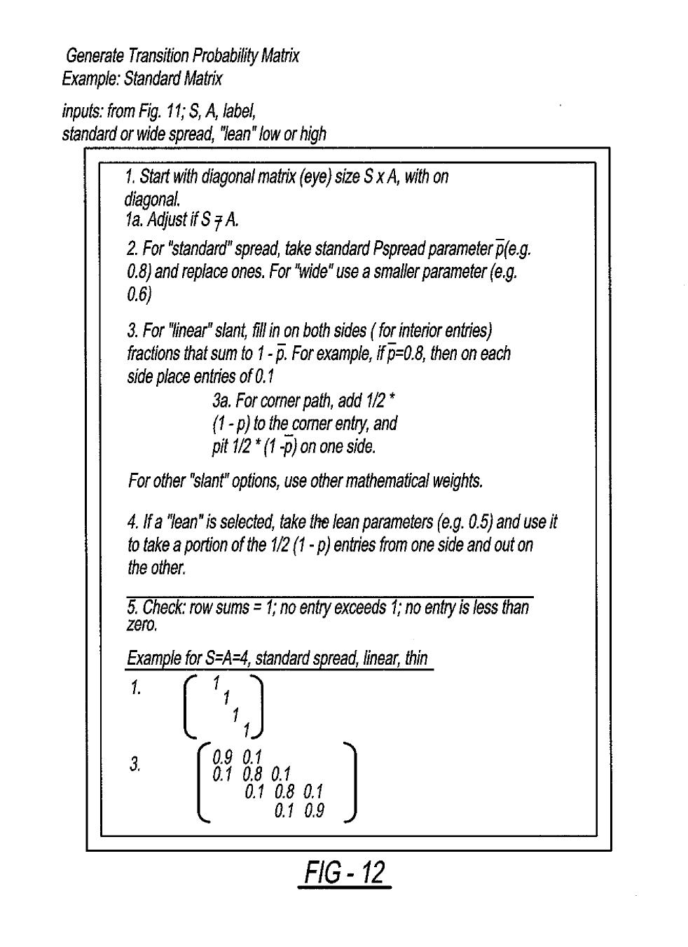

A transition probability function is defined based on user inputs (FIG. 11). This function determines the likelihood of achieving a given future state based on the occurrence of specific action within the action space. The methodology may assume that the user has some knowledge that can be incorporated into the transition probability function. The transition probability function can be expressed mathematically in the form of a matrix.

An example of a transition probability matrix is illustrated in FIG. 12. The user may be requested to provide certain information such as a size of a matrix as determined by the number of states and possible actions. The user may be prompted to select a predetermined influence on the distribution, such as a predetermined skew or slant (i.e. skew means right or left). The user may also be prompted to select a predetermined type of variance or spread of the distribution, such as thin, or wide or the like.

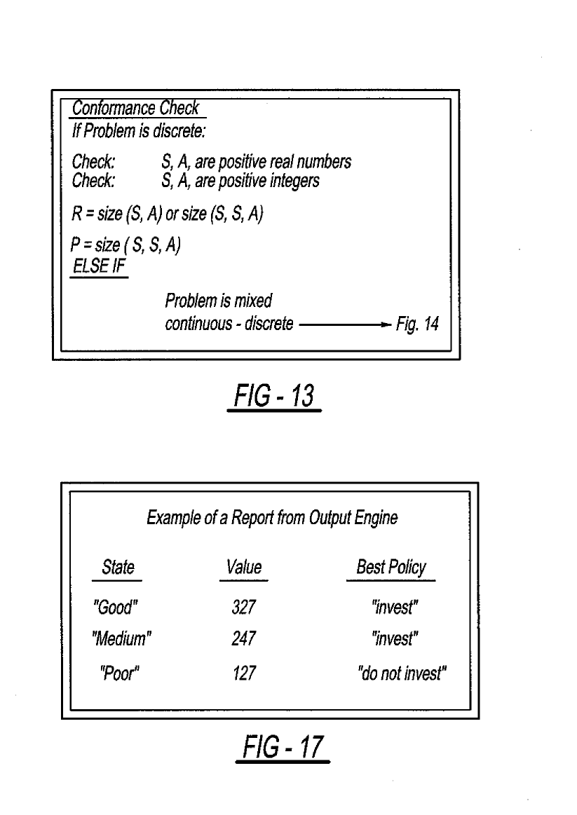

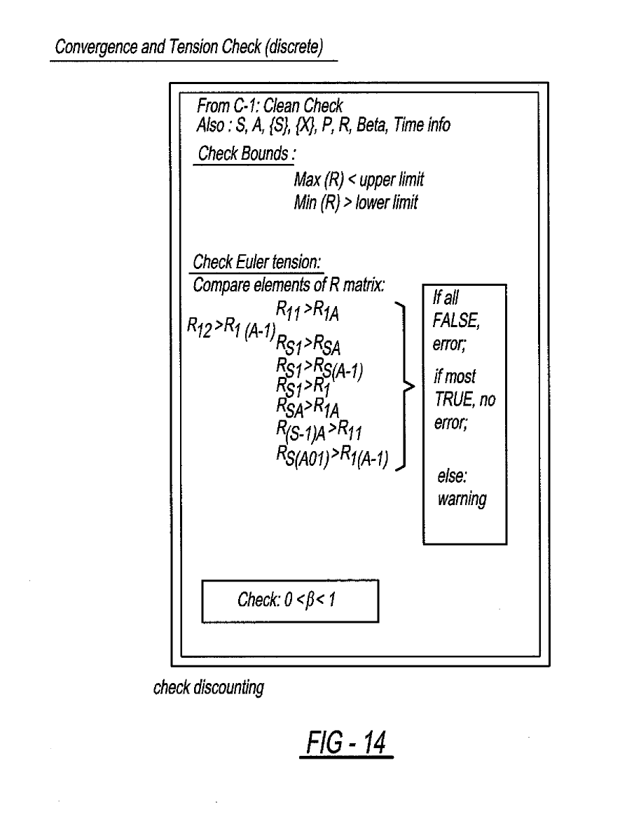

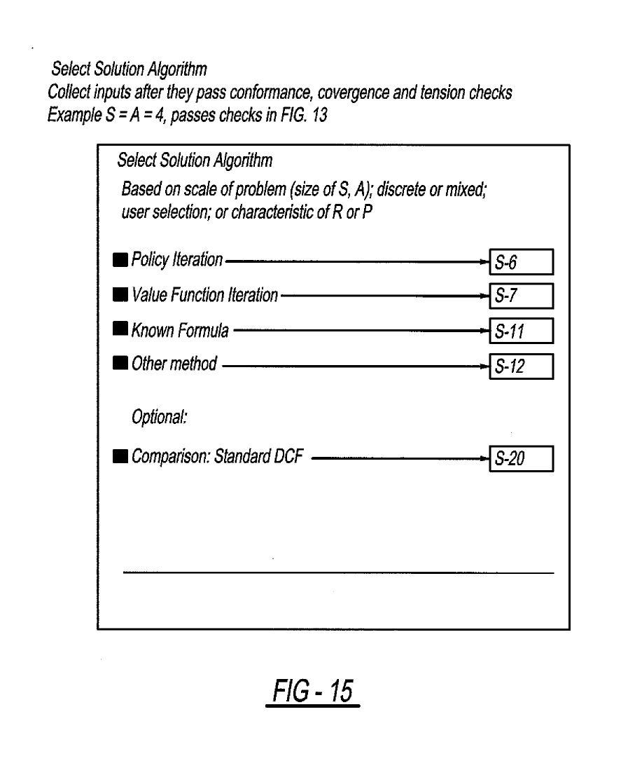

The transition matrix is generated based on the user supplied transition inputs as shown in FIG. 12 for an example of a standard matrix. The methodology may perform a conformance check on the generated transition matrix (FIG. 13). For example, the methodology may check the values in the matrix against a predetermined rule. An example of a predetermined rule is that the defined problem is discrete.

Referring to FIG. 14, an example of a convergence and tension check is performed. The convergence and tension (or trade-off) checks evaluate the solvability of the problem. Types of checks include checking upper and lower limits or boundaries of the reward. Still a further type of check is whether the discount factor is greater than zero and less than one. Advantageously, the validity of the data may be checked at various steps during the methodology or it may be checked before any calculations are performed.

A discount factor which represents a preference for receiving a benefit now relative to in the future can be determined and used in the methodology.

The user can determine a time index. The time index represents how often an action from the action space is performed, how often a reward is received, and how often the state can change.

A transition probability function is defined using the states, actions, reward function, discount factor and time index. The transition probability function is shown in FIG. 12.

A solution algorithm is illustrated in FIG. 15. The user may select the solution algorithm or the methodology may automatically select the solution algorithm. Factors that may influence the selection of the solution algorithm include the scale of problem to be solved, if the solution is discrete, and reward matrix characteristics. Examples of solution algorithms include a policy iteration, discounted cash flow model, value function iteration, or some other formula. The analysis seeks to maximize the value to the user across all possible actions for each element in the state space. The analysis engine performs a set of computations to solve the functional equation. The analysis engine may maximize the sum of the current reward and the expected discounted future value, where the problem is described as a value functional problem. Alternatively, a minimum value may be targeted in the instance of minimization problem.

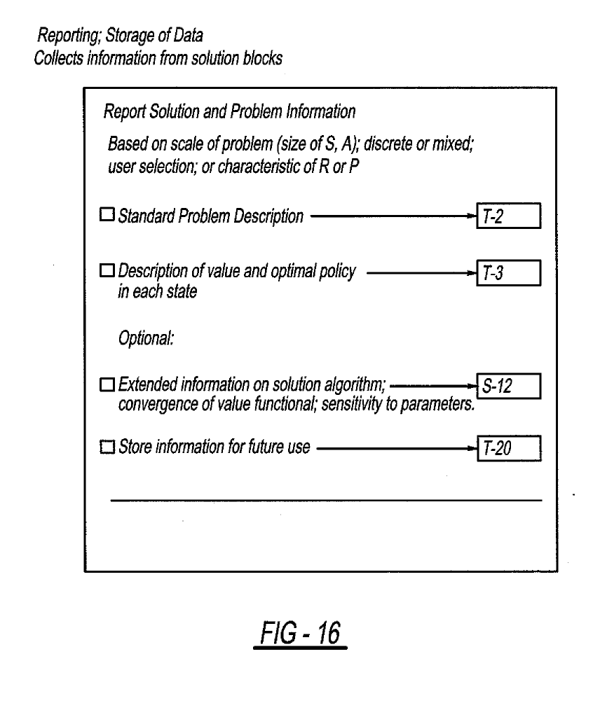

The user can select how to receive the problem solution. For example, as shown in FIG. 16, the user may be provided with a screen displaying reporting options. For example, the output, such as graphics, text or audio or the like, may be provided to the user on the user display device as shown in FIG. 16. The output may be in a format that may provide the user with solutions to the functional equation, and possibly a comparison of solutions based upon the states, rewards, discounts, and possible actions. The solution provided to the user is predictive, since it provides information concerning various possible states and outcomes.

An example of a report or advice that may be displayed or otherwise provided (e.g., printed) at a user output interface is shown in FIG. 17.

The order of the steps to perform the method are illustrative, and certain steps can be rearranged without deviating from the overall decision making methodology.

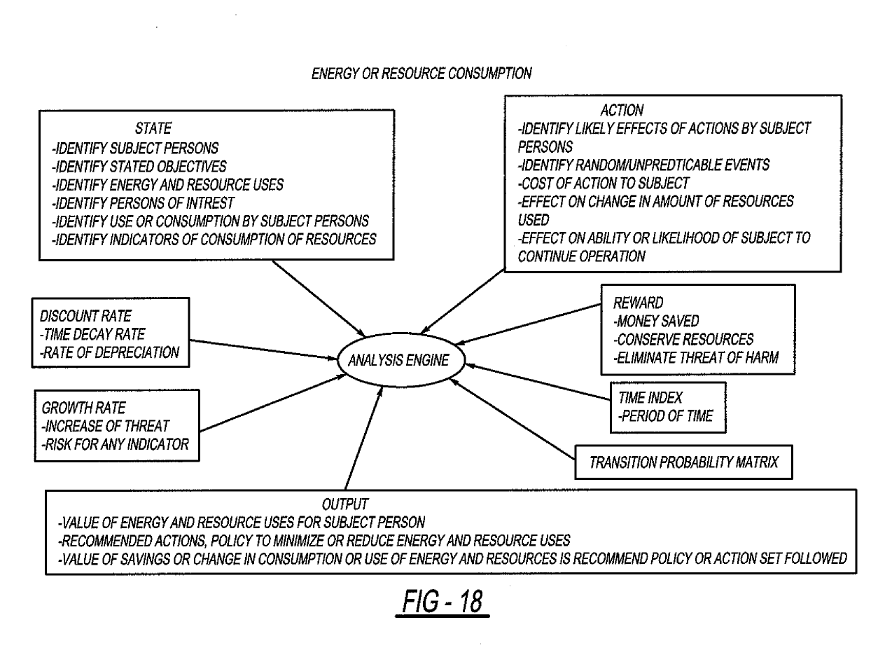

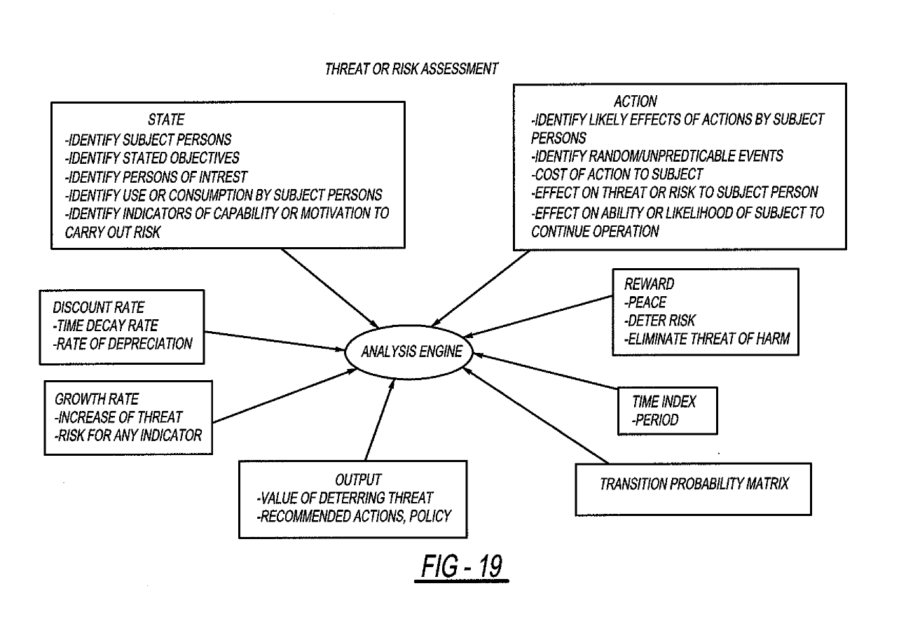

Other examples of using a method as disclosed herein to make a decision include threat or risk assessment (FIG. 19), energy efficiency investment analysis (FIG. 18), and financial analysis. The disclosed systems and methods of decision making are applicable to any type of problem, and the illustrated problems are merely exemplary.

Many modifications and variations of the present disclosure are possible in light of the above teachings. Therefore, within the scope of the appended claims, the present disclosure may be practiced other than as specifically described.

1. A computer-aided decision-making system, comprising:
(a) a processor;
(b) a user input interface;
(c) a user output device; and
(d) a program executed by the processor to evaluate decision making opportunities, the program (A) facilitating input of relevant information from a database and/or from a user via the user input interface, (B) validating input, checking for errors, and facilitating correction of input errors, (C) generating the following elements from the information: (i) a set of states that describe possible outcomes, (ii) a set of possible actions that may be taken by a decision maker, (iii) a transition probability function representative of the likelihood of a particular state occurring at a future time based on the current state and a particular action taken by the user, (iv) a reward function representative of the benefits and costs associated with each possible action and state, (v) a discount factor that is representative of the relative preference for receiving a benefit now and at the future time, and (vi) a time index that establishes a sequential ordering of events, (D) formulating the elements into a functional equation, (E) solving the functional equation, and (F) presenting the user with decision-making advice via the user output device.

2. A computer-aided decision-making system in accordance with claim 1, wherein the value of each state is determined recursively, on the basis of a specified map of actions that could be taken, to maximize the sum of current rewards and expected discounted future value.

3. A computer-aided decision-making system in accordance with claim 1, wherein the value of each state is determined recursively, on the basis of a specified map of actions that could be taken, to minimize the sum of current costs, burdens, or penalties and expected discounted value of future costs, burdens, or penalties.

4. A computer-aided decision-making system in accordance with claim 1, wherein the state space is a discrete list of states of a finite number.

5. A computer-aided decision-making system in accordance with claim 1, wherein the state space is an interval on the real number line, or a combination of one or more discrete lists and intervals on the real number line.

6. A computer-aided decision-making system in accordance with claim 1, wherein the discount factor is determined on the basis of the time value of money as perceived by the person; the risk associated with the subject person, operation or problem; the market rate of interest; the rate of interest on securities or the rate of interest on financial contracts.

7. A computer-aided decision-making system in accordance with claim 1, wherein the analysis engine relies upon a transition function or a transition matrix.

8. A computer-readable medium encoded with instructions that cause a data processing system to perform a process comprising: (A) facilitating input of relevant information from a database and/or a user via a user input interface, (B) validating input, checking for errors, and facilitating correction of input errors, (C) generating the following elements from the information: (i) a set of states that describe possible outcomes, (ii) a set of possible actions that may be taken by a decision maker, (iii) a transition probability function representative of the likelihood of a particular state occurring at a future time based on the current state and a particular action, (iv) a reward function representative of the benefits and costs associated with each possible action and state, (v) a discount factor that is representative of the relative preference for receiving a benefit now and at the future time, and (vi) a time index that establishes a sequential ordering of events, (D) formulating the elements into a functional equation, (E) solving the functional equation, and (F) presenting the user with decision-making advice via a user output device.

9. A method for assisting a person in making a decision using a rapid recursive analysis, said method comprising the steps of:
selecting a problem to be solved by a user via a user computer having a processor, a user input device, and a user output device;
providing the user with a user selectable option for defining at least one state associated with the selected problem, wherein the user indicates the state via the user input device;
validating the user defined state, wherein the user may provide additional information if the user defined state is not validated;
providing the user with a user selectable option for defining at least one action associated with the selected problem, wherein the user indicates the action via the user input device;
providing the user with a user selectable option for defining a possible reward associated with the selected problem, wherein the user indicates the possible reward via the user input device and the possible reward is a potential benefit associated with the selected problem;
providing the user with a user selectable option for defining a discount factor associated with the selected problem, wherein the user indicates the discount factor via the user input device;
providing the user with a user selectable option for defining a time index associated with the selected problem, wherein the user indicates the time index via the user input device and the time index is expressed in periods associated with the selected problem;
validating the action, reward, discount factor and time index, wherein the user may provide additional information if not validated;
providing the user with a user selectable option for selecting a solution method for solving the selected problem;
solving the problem using the selected method to determine a solution to the selected problem; and
providing the user with the solution to the selected problem on the output device.

10. A method as set forth in claim 9, wherein the step of providing the user a user selectable option for defining a state further includes providing the user an option to select a predefined state or a user defined state.

11. A method as set forth in claim 9, wherein the step of providing the user a user selectable option for defining a state further includes a step of providing the user with a user selectable option for defining a growth rate associated with the selected problem, wherein the user indicates the growth rate via the user input device and the growth rate is a growth rate factor associated with the selected problem.

12. A method as set forth in claim 9, wherein the step of providing the user a user selectable option for defining a state further includes a step of providing the user with a user selectable option for defining a discount rate associated with the selected problem, wherein the user indicates the discount rate via the user input device and the discount rate is a reduction rate factor associated with the selected problem.

13. A method as set forth in claim 9, wherein said step of providing the user a user selectable option for defining an action further includes providing the user an option to select a predefined action or a user defined action.

14. A method as set forth in claim 9 wherein the step of providing the user with a user selectable option for defining a possible reward associated with the selected problem further includes a step of setting up a reward matrix to determine the reward associated with each combination of state and action.

15. A method as set forth in claim 9 further comprising a step of providing the user with a user selectable option for defining a shape of the growth path of the reward with respect to time, the set of actions, and/or set of states.

16. A method as set forth in claim 9 wherein the step of validating the user defined state includes requesting that the user provide additional input when the step of validating the user defined state determines it is appropriate.

17. A method as set forth in claim 14 further comprising generating a transition probability function that is expressed in the form of a transition probability matrix.

18. A method as set forth in claim 17 further comprising the step of providing the user a user selectable option for defining a size, mean and variance for the transition probability matrix and adjusting the transition probability matrix according to the size, mean and variance.

19. A method as set forth in claim 17 further comprising a step of validating the transition probability matrix by performing a conformance check of the transition probability matrix.

20. A method as set forth in claim 17 further comprising a step of validating the transition probability matrix and the reward matrix by performing a convergence check.

21. A method as set forth in claim 20 wherein the step of validating the transition probability matrix and reward matrix further includes a step of performing a tension (or trade-off) check.

22. The method of claim 9 wherein the solution method is selected from a set including policy iteration and value function iteration.

23. The method of claim 9 wherein the solution to the selected problem maximizes the sum of the current reward and the expected discounted future value.
